(19) United States
(12) Patent Application Publication
(10) Pub. No.: US 2014/0044267 A1
(43) Pub. Date: Feb. 13, 2014

(54) Methods and Apparatus For Media Rendering

(71) Applicant: Juha P. Ojanpera, Nokia (FI)

(72) Inventor: Juha P. Ojanpera, Nokia (FI)

(73) Assignee: Nokia Corporation

(21) Appl. No.: 13/572,118

(22) Filed: Aug. 10, 2012

(51) Int. Cl. H04R 29/00

(52) U.S. Cl. 381/56

(57) ABSTRACT

Systems and techniques for processing of media content information are described. Similarity information is determined for a plurality of media content segments captured by different devices that may be distributed through a space. The similarity information may define similarities between segments of media content overlapping in time. At least one transition pattern determines transitions between media content segments such as from an old content segment earlier in a timeline to a new content segment later in the timeline, with the new content segment being chosen based at least in part on similarity to the old content segment.

### FIELD OF THE INVENTION

The present invention relates generally to media recording and presentation. More particularly, the invention relates to organizing and rendering of media elements from a plurality of different sources.

### BACKGROUND

Modern electronic devices provide users with a previously unimagined ability to capture audio and video media. Numerous users attending an event possess the ability to capture video and audio media, and the ability to communicate captured media to others and to process media. In addition, the proliferation of electronic devices with media capture and communication capabilities allows for multiple users attending the same event, for example, to capture video and audio of the event from numerous different vantage points. Each device may capture an audio segment, and the audio information, together with time and position information, may be provided to a central server. Timing information may be used to synchronize audio segments from different sources, and position information can be used to inform the creation of a soundscape, which may be an audio field as perceived at a specified listening point, which may be one of a plurality of available listening points, selected by a provider or by a user, or automatically determined based on a position of a user.

### SUMMARY OF THE INVENTION

In one embodiment of the invention, an apparatus comprises at least one processor and memory storing computer program code. The memory storing the computer program code is configured to, with the at least one processor, cause the apparatus to at least determine similarity information relating to media content segments associated with different sources and determine at least one pattern of transitions between media content segments based at least in part on the similarity information.

In another embodiment of the invention, a method comprises determining similarity information relating to media content segments associated with different sources and determining at least one pattern of transitions between media content segments based at least in part on the similarity information.

In another embodiment of the invention, a computer readable medium stores a program of instructions. Execution of the program of instructions by a processor configures an apparatus to at least determine similarity information relating to media content segments associated with different sources and determine at least one pattern of transitions between media content segments based at least in part on the similarity information.

### BRIEF DESCRIPTION OF THE DRAWINGS

FIG. 1 illustrates a content space in which content may be captured and processed according to an embodiment of the present invention;

FIGS. 2 and 3 illustrate processes according to embodiments of the present invention;

FIG. 4 illustrates a timeline of overlapping content that may be processed according to an embodiment of the present invention;

FIG. 5 illustrates a process according to embodiments of the present invention; and

FIG. 6 illustrates elements according to an embodiment of the present invention.

### DETAILED DESCRIPTION

Embodiments of the present invention recognize that content elements from multiple users carry substantial information relating to each content element, such as the position of the source of each content element, the time of events, the proximity of a content source to the event being captured, and other information. Embodiments of the present invention further recognize that the content rendering creates a summary of content captured by multiple users and that it is important from the end user's point of view that the summary focus on relevant moments in the audio-visual space Important information includes relationships, such as proximity of a content source to an event at the time of the event, and such information can be used to switch from content captured by one user to content captured by another user, in order to allow for user of the best source or sources of content relating to the particular event in question. One approach to switching from one source to another is to perform switching in such a way as to provide a logical narrative sequence. For example, at a concert, a sound field may be rendered so that it is perceived to move toward the stage. One or more embodiments of the present invention provide for the collection and interpretation of information relating to content items, particularly audio content items or audio portions of audio-video content items, so as to render content to provide desired experiences for the end user, such as a particular apparent listening point or selection or sequence of apparent listening points.

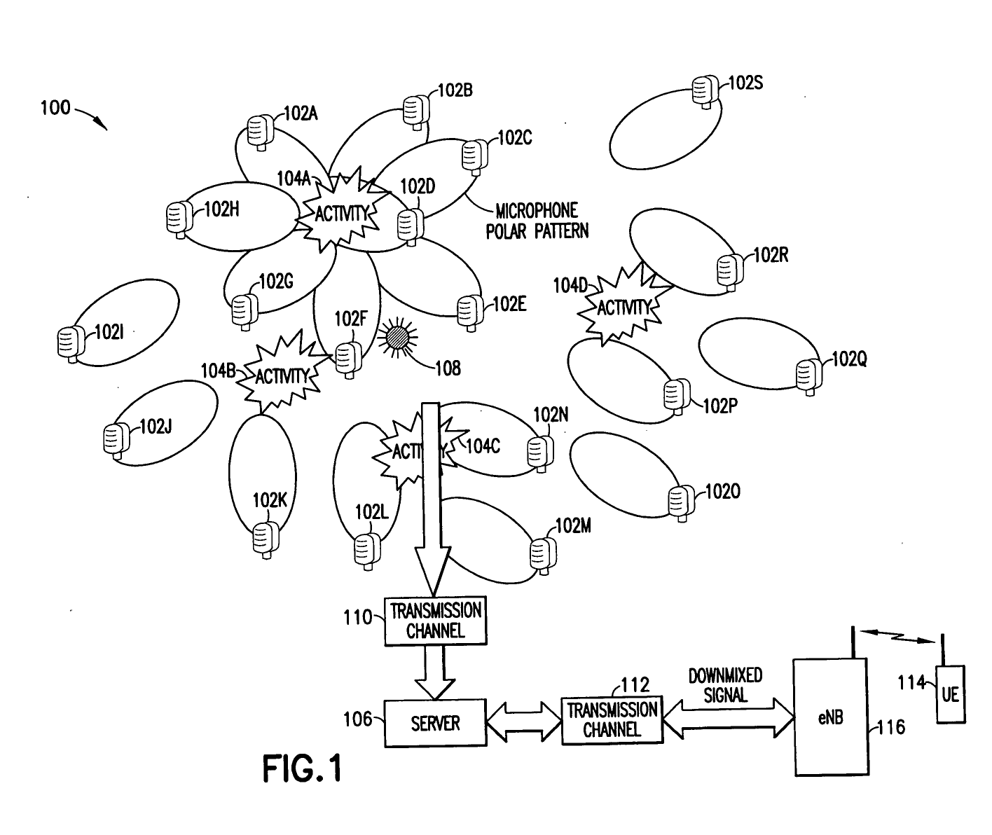

FIG. 1 illustrates an audio space 100, in which are deployed a number of devices 102A-102S, each represented as having audio capture capability, so that each device is depicted as a microphone. It will be recognized, however, that the devices 102A-102S will not typically be simply microphones, but may have, for example, video capture capabilities. One or more of the devices 102A-102S may also have data processing and wireless communication capabilities, and one example of a commonly encountered device that may serve as the devices 102A-102S is a smartphone.

The devices may be thought of as arbitrarily positioned within the audio space to record an audio scene, in the same way that individual users would likely be arbitrarily positioned within a space based on their own individual preferences, rather than based on any sort of coordinated distribution. The audio scene may comprise events 104A-104D. As audio is captured, signals are transmitted to, for example, a content server 106. Alternatively, one or more of the devices 102A-102S may store captured signals for later processing or presentation.

The server 106 renders signals to reconstruct the audio space, suitably from the perspective of a listening point 108, or a selection or sequence of listening points. The server 106 may receive the signals through a transmission channel 110, and may deliver the rendered content over a transmission channel 112 to an end user device 114. The end user device 114 may suitably be a user equipment (UE) such as may operate in a third generation preferred partnership (3GPP) or 3GPP long term evolution (LTE) network, and may receive the rendered content through transmission from a base station, suitably implemented as a 3GPP or 3GPP LTE eNodeB (eNB). The end user device 114 may allow selection of a listening point by or on behalf of the end user, based, for example, on user selections or preferences. The server 106 may provide one or more downmixed signals from multiple sound sources providing information relevant to the selected listening point.

In FIG. 1, the microphones of the devices are shown to have a directional beam, but embodiments of the invention may use microphones having any form of suitable beam. Furthermore, not all microphones need to employ similar beams. Instead, microphones with different beams may be used. The downmixed signal or signals may be a mono, stereo, binaural signal or it may consist of multiple channels. In an end-to-end system context, each device captures audio content, and may also capture video content. The content is uploaded or upstreamed, either in real time or non real time, to server 106. The uploaded or upstreamed information may also include o positioning information indicating where the audio is being captured and the capture direction or orientation.

A device may capture one or more audio or audio-visual signals. If a device captures (and provides) more than one signal, the direction or orientation of these signals may differ. The position information may be obtained, for example, using GPS coordinates, Cell-ID or A-GPS and the recording direction or orientation may be obtained, for example, using compass, accelerometer or gyroscope information. In one or more embodiments of the invention, many users or devices may record an audio scene at different positions but in close proximity.

The server 106 may receive each uploaded signal and keep track of the positions and the directions and orientations associated with the uploaded signal. Initially, the server 106 may provide high level coordinates, which correspond to locations where user uploaded or upstreamed content is available for listening (and viewing), to the end user device 114. These high level coordinates may be provided, for example, as a map to the end user device for selection of the listening position. The end user device 114, for example, by means of an application running on the end user device 110 determines the listening position and sending this information to the content server 106. Finally, the server 106 transmits to the end user device 114 a downmixed signal corresponding to the specified location.

Alternatively, the server 106 may provide a selected set of downmixed signals that correspond to listening or viewing point, allowing selection of a specific downmixed signal by the end user. In some cases, the content of an audio scene will encompass only a small area, so that only a single listening position need be provided. Furthermore, a media format encapsulating the signals or a set of signals may be formed and transmitted to the end users. The downmixed signals in the context of the invention may refer to audio only content or to content where audio is accompanied with video content.

One or more embodiments of the present invention create summary data associated with multi-user content. The summary data may be indexed to address the content space as a function of time, indicating when to switch between sources, and time as a function of space, indicating the sources between which to switch. Correlated signal pair data is created for overlapping time segments and content, and multiple signal pair data is indexed to find switching patterns for multi-user content, and to transition from one source to another for the same content.

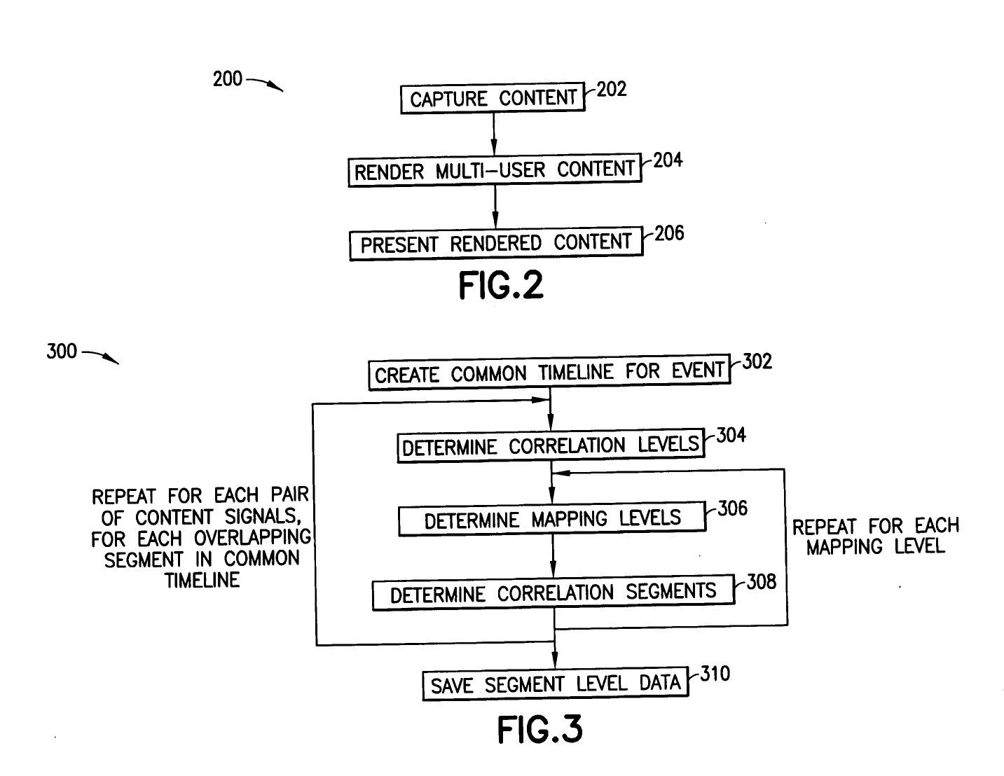

FIG. 2 illustrates a high-level process of content rendering according to an embodiment of the present invention. At step 202, content relating to an event is captured. An event may be regarded as any occurrence producing sound. Capture may suitably be from numerous different perspectives, such as at different positions, distances, and orientations, and capture may be accomplished for example, by a plurality of user devices controlled by individual users present in an audio space. At step 204, the multi-user content is rendered using mechanisms described in greater detail below. At step 206, the rendered content is presented, such as by transmission to a user device capable of audio playback of the rendered content.

FIG. 3 illustrates a process 300, comprising detailed steps performed in content rendering. At step 302, a common timeline is created for the event. Then, for each overlapping time segment, operations are performed for pairs of content signals. At step 304, correlation levels are determined that describe the similarity of the signals as a function of time.

At step 306, mapping levels are determined representing the number of similarity levels to be calculated for a rendered output. At step 308, correlation levels are mapped into time segments describing the start and duration of a segment for a particular mapping level. Steps 306 and 308 are repeated for each mapping level. At step 310, the segments are stored for later use.

For each overlapping segment s, the level data is determined as follows:

First, a similarity level for a content signal pair (x,y) of length xyLen is determined according to

$${c}_{xy}^{s} ( i ) = \vert \frac{x ( i )}{y ( i )} \vert , \\ 0 \leq i < xyLen \qquad ( 1 )$$

Next, the correlation level thresholds are determined. These thresholds define the degree of similarity of the signal pair for each level in the output level data. If the change in similarity is defined to be D dB and the number of levels is set to L, then the thresholds are calculated according to

$$\{ \begin{matrix}{cThr}_{max} ( i ) = {10}^{0.1 \cdot D \cdot ( i + 1 )} \\ {cThr}_{min} ( i ) = {10}^{- 0.1 \cdot D \cdot ( i + 1 )}\end{matrix} , \\ 0 \leq i < L \qquad ( 2 )$$

Equation (2) is determined for the entire timeline. That is, D is the same for all overlapping segments. For the sake of simplicity, the threshold computation is shown to be part of the signal pair processing it will be recognized that embodiments of the invention may be implemented to calculate this value only once for all overlapping segments.

Then, for each pair within the segment the following steps are performed. First, the correlation data is applied through a binary filter according to

$${c}_{xy \_ l}^{s} ( i ) = \{ \begin{matrix}1 , & \begin{matrix}{cThr}_{min} ( l ) \leq {c}_{xy}^{s} ( i ) < {cThr}_{max} ( l ) \\ or\end{matrix} \\ 0 , & \begin{matrix}( \begin{matrix}\begin{matrix}{cThr}_{min} ( l - 1 ) \leq {c}_{xy}^{s} ( i ) < {cThr}_{max} ( l - 1 ) \\ and\end{matrix} \\ {c}_{xy\_ ( l - 1 )}^{s} ( i ) == 0\end{matrix} ) \\ otherwise\end{matrix}\end{matrix} , \\ 0 \leq i < xyLen$$

where l−1=−1 is considered invalid condition and is therefore ignored. Equation (3) finds those indices from that c_{xy}_{_{—}}ₗ^{s} that are either within the specified threshold interval or for which the output from the previous level (if valid) was assigned a value of 0. Next, the filtered output vector is mapped into continuous segments (segInterData) according to following procedure:

| | |
|---|---|
| 1 | segInterData = [ ] |
| 2 | For n = 0 to xyLen − 1 |
| 3 | { |
| 4 | startPos = n |
| 5 | startVal = c_{xy}_ₗ^{s}(n); n++ |
| 6 | endPos = n |
| 7 | |
| 8 | While n < xyLen and startVal == c_{xy}_ₗ^{s}(n) |
| 9 | n++; |
| 10 | endPos = n; |
| 11 | |
| 12 | segInterData.append(startVal, startPos, endPos, endPos − startPos) |
| 13 | } |

The above procedure determines segment boundaries for each successive 0- or 1-valued index and creates a vector that describes the data associated with these boundaries. The data vector includes the value of the segment (0 or 1), the start and end index, and the length of the segment, in line 12.

Next, the segments are post-processed such that short duration segments of value 0 between segments of value 1 are removed (merged to value 1), and short duration segments of value 1 between segments of value 0 are removed (merged to value 0). For this purpose the following procedure is first applied with parameters (p1=1, p2=0, p3=1, tThr=5 sec, tThr2=10 sec) and then with parameters (p1=0, p2=1, p3=0, tThr=5 sec, tThr2=10 sec):

| | |
|---|---|
| 1 | Start: |
| 2 | For n = 0 to length(segInterData) − 1 |
| 3 | { |
| 4 | If segInterData[n−1][0] == p1 and |
| | segInterData[n][0] == p2 and |
| | segInterData[n+1][0] == p3 and |
| | segInterData[n−1][3] * timeRes >= tThr2 and |
| | segInterData[n+1][3] * timeRes >= tThr2 and |
| | segInterData[n][3] * timeRes < tThr |
| 5 | |
| 6 | nw = [segInterData[n+1][0], |
| | segInterData[n−1][0], |
| | segInterData[n+1][1], |
| | segInterData[n+1][1] − segInterData[n−1][0]] |
| 7 | Delete indices n−1, n, n+1 and replace them with nw |
| 8 | c_{xy}_ₗ^{s}(nw[1], ..., nw[2])= p1 |
| 9 | Goto Start |
| 10 | } |

where length( ) returns the length of the specified vector and timeRes describes the time resolution of the input signal pair. Line 4 checks whether there is a short duration segment of value 0 (1) between long duration segments of value 1 (0) and if the condition is true the segments are merged into single segment in lines 6-8 (and vice versa). The above procedure filters out short-term inconsistencies in the correlation level data that are bound to exist in the signal pair. Such inconsistencies exist because the signals exhibit small differences with respect to one another even if they describe the same scene).

Finally, the level data is extracted for storage according to the following procedure:

```
levelData = [ ]
For n = 0 to length(segInterData) − 1
{
  If segInterData[n][0] == 1
  levelData.append(segInterData[n][1] * timeRes)
  levelData.append(segInterData[n][2] * timeRes)
}
Save levelData for later consumption
```

Thus, the level data describes for each segment of value 1 the start of the segment and the end of the segment with respect to the start of the content pair. Equation (3) and the above procedures are repeated for 0≦i<L.

The level data describes the similarity of the pair as a function of time. For 1=0, the data describes the segments where similarity is strongest among the signal pair. As 1 increases, the similarity of the signal pair decreases. In one or more embodiments of the invention, ordering and selection may be based on relative differences between signal pairs, with absolute differences being unimportant. For example, the following level data may be produced for some arbitrary signal pair when data from each level is combined:

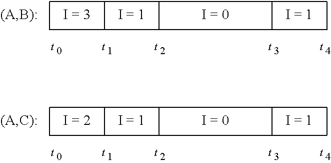

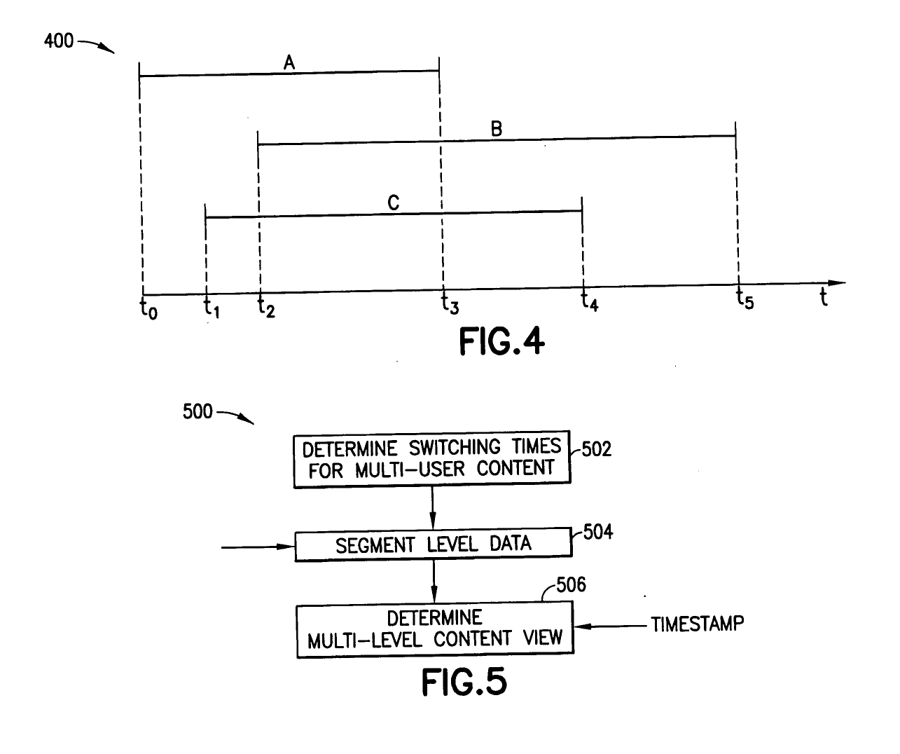

FIG. 4 illustrates overlapping segments in the timeline. The level data is calculated for the following segments and signal pairs:
t₁-t₂: (A, C)
t₂-t₃: (A, B), (A, C), (13, C)
t₃-t₄: (B, C)

FIG. 5 illustrates a process 500 according to an embodiment of the present invention, of using the level data to acquire various switching patterns for the multi-user content as performed at steps 502 and 504. The switching patterns may be used, for example, as a time instant when content is to be switched from one source to the other. The following description outlines one exemplary way of acquiring switching pattern from the level data that describes the multi-user content scene.

Let ldₛₑₜ₍ⱼ₎_{_{—}}ₗ^{s} describe the level data for overlapping segment s that covers signal pairs 0≦j<3 with set={(A, B), (A, C), (B, C)} where A, B, and C are the corresponding content pairs for the segment.

First, the signal pairs are organized by order of importance. The ordering can take place by calculating the duration of the 0-level data and ordering the pairs based on the duration. The pair that has the longest duration appears first; the pair that has the second longest duration appears next, and so on. If two or more pairs have the same duration, the ordering for those pairs may be based on the duration of the 1-level data. This approach is continued until all pairs have been ordered. If pairs have same level data composition for all levels then ordering can be, for example, random.

Next, the time instances from the first pair corresponding to the 0-level data are extracted. If the amount of time instances is not enough, the next pair from the ordered set is considered. The time instants corresponding to the 0-level data are now considered from this pair as an addition to the existing list of time instances. New time instances from the pair are added to the list if there are no existing time instances defined in the vicinity of the new time instant. If the distance of the time instance to be added to the nearest time instance in the existing list is greater than, say 2 sec, the new time instance is added to the list, otherwise the time instance is discarded. This overlay of time instances from different pairs to the existing list may be repeated for all pairs if too few time instances are represented

It is also possible that new additions are not considered for the whole time period of the segment but only for a certain sub-segment within the time segment. If the 0-level data is not able to create enough switching points, the next step is to consider the 1-level data and try to add time instances from there to the existing time instances list. This approach may be continued for all levels in the level data if so desired.

The level data can also be used to acquire different content source at a specified time instance as shown at steps 504 and 506 of the process 500 of FIG. 5. In this mode, the time instance and the content source used up to the specified time instance are known, and the unknown is what content source should be used next in the downmixed signal.

Consider a time instant t, with c being the content source used prior to t. The next content source for time instant after t can be determined from the level data as follows:

First, the overlapping segment from the timeline that includes position t is searched. Let the level data pairs corresponding to the identified segment be {(c,d), (c,e), (d,e)}. Next, the level data sub-segment matching the position t is identified. In an example, the next content source may be chosen based on similarity of content. The content source chosen may be, for example, the source providing content exhibiting the most similar level to that of content c, the longest same-level duration as that of content c, or both.

In another example, the content may be selected on the basis of dissimilarity. In such a case, the next source chosen might be the source exhibiting the most different level from that of content c, the longest level difference duration with that of content c, or both. In another approach, content sources chosen next in sequence may gradually as a function of time. That is, as time passes, difference criteria may change to call for the selection of content sources exhibiting greater differences, or may change to call for the selection of content sources exhibiting lesser differences.

Any number of alternative approaches may be used. For example, a content signal pair can be an audio signal either directly in a time domain format or in some other representation domain format that may be derived from the time domain signal, such as various transforms, feature vectors, and other derivative representations.

If the total number of levels for the timeline is limited, as may be the case if, for example, most of the data appears to be in L-1 (or 0) level, then the threshold D may be increased (or decreased). The level data may be recalculated for the overlapping segment pairs. The calculation steps may also be repeated until some target distribution of the levels is achieved (say, 50% belongs to 0-level, 25% to 1-level, 15% to 2-level, and 10% to 3-level).

In addition, in some embodiments of the invention, computation of switching patterns such as those described above may be applied only to certain segments in the timeline. Traditionally for music segments, switching patterns that are a function of the beat structure of the music are typically preferred. In such cases, determination of switching patterns based on level data when underlying content is music may not be desired.

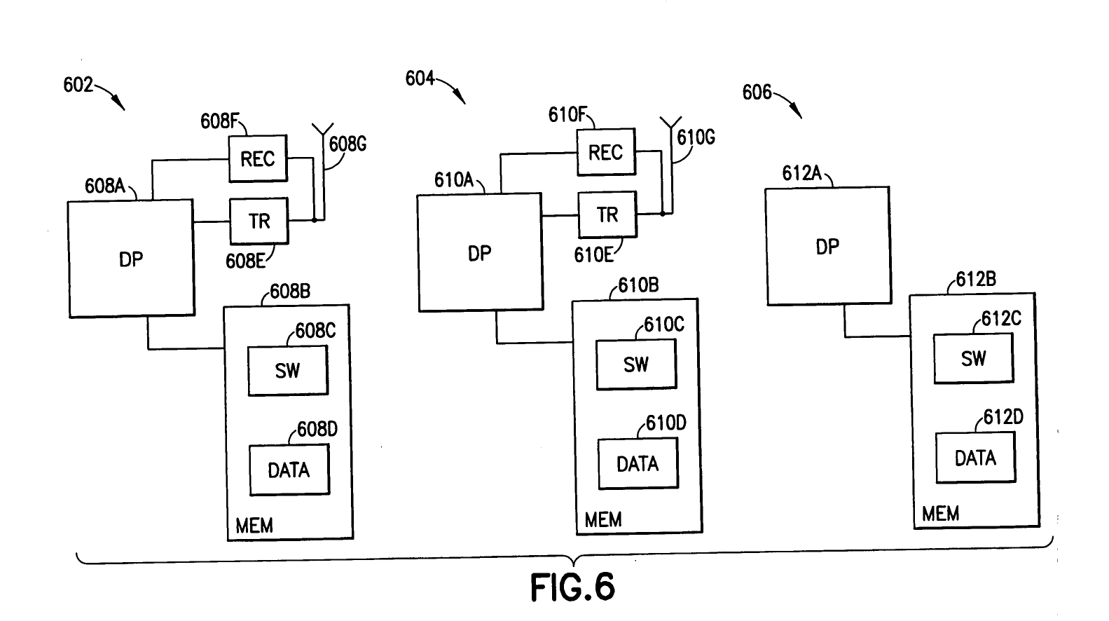

FIG. 6 illustrates exemplary network elements that may be used in a deployment such as the deployment 100. Elements include a user device, implemented here as a UE 602, a base station 604, implemented as an eNB, and a server 606. The user devices 102A-102S of FIG. 1 may be UEs such as the UE 602, and the end user device 114 may also be a UE similar to the UE 602. The UE 602 comprises a data processor 608A and memory 608B, with the memory 608B suitably storing software 608C and data 608D. The UE 602 also comprises a transmitter 608E, receiver 608F, and antenna 608G. Similarly, the base station 604 comprises a data processor 610A, and memory 610B, with the memory 610B suitably storing software 610C and data 610D. The base station 604 also comprises a transmitter 610E, receiver 610F, and antenna 610G. The server 606 comprises a data processor 612A and memory 612B, with the memory 612B suitably storing software 612C and data 610D.

At least one of the software 608A-612C stored in memories 608B-612B is assumed to include program instructions (software (SW)) that, when executed by the associated data processor, enable the electronic device to operate in accordance with the exemplary embodiments of this invention. That is, the exemplary embodiments of this invention may be implemented at least in part by computer software executable by the DP 608A-612A of the various electronic components illustrated here, with such components and similar components being deployed in whatever numbers, configurations, and arrangements are desired for the carrying out of the invention. Various embodiments of the invention may be carried out by hardware, or by a combination of software and hardware (and firmware).

The various embodiments of the UE 602 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memories 608B-612B may be of any type suitable to the local technical environment and may be implemented using any suitable data storage technology, such as semiconductor based memory devices, flash memory, magnetic memory devices and systems, optical memory devices and systems, fixed memory and removable memory. The data processors 608A-612A may be of any type suitable to the local technical environment, and may include one or more of general purpose computers, special purpose computers, microprocessors, digital signal processors (DSPs) and processors based on multi-core processor architectures, as non-limiting examples.

A separate server 606 is illustrated here, but it will be recognized that numerous elements used in embodiments of the invention are capable of providing data processing resources sufficient to perform content rendering and organizing for presentation. For example, a user device such as the user devices 102A-102S and 602 may act as a server node.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. An apparatus comprising:
at least one processor;
memory storing computer program code;
wherein the memory storing the computer program code is configured to, with the at least one processor, cause the apparatus to at least:
determine similarity information relating to media content segments associated with different sources; and
determine at least one pattern of transitions between media content segments based at least in part on the similarity information.

2. The apparatus according to claim 1, wherein the sources are media capture devices distributed in a space, and wherein each media content segment comprises data captured by a device during a specified time period, and wherein similarity information is determined based at least in part on similarity between data captured by different devices during the same time period.

3. The apparatus according to claim 2, wherein similarity information is determined between pairs of media content segments, and wherein pairs are organized based on similarity between members of pairs as a function of time.

4. The apparatus according to claim 1, wherein the at least one pattern of transitions defines transitions during a timeline for which a plurality of media content segments overlap in time and wherein the at least one pattern of transitions specifies a sequence of media content segments to be selected to represent the timeline.

5. The apparatus according to claim 4, wherein the sequence of media content segments defines at least one transition time and specifies a new media content segment to which a transition is to be made from an old media content segment at the at least one transition time, based at least in part on similarity between the old media content segment and the new media content segment.

6. The apparatus according to claim 1, wherein at least one of the media content segments is an audio only segment.

7. The apparatus according to claim 1, wherein at least one of the media content segments includes audio and video.

8. A method comprising:
determining similarity information relating to media content segments associated with different sources; and
determining at least one pattern of transitions between media content segments based at least in part on the similarity information.

9. The method according to claim 8, wherein the sources are media capture devices distributed in a space, and wherein each media content segment comprises data captured by a device during a specified time period, and wherein similarity information is determined based at least in part on similarity between data captured by different devices during the same time period.

10. The method according to claim 9, wherein similarity information is determined between pairs of media content segments, and wherein pairs are organized based on similarity between members of pairs as a function of time.

11. The method according to claim 8, 9, or 10, wherein the at least one pattern of transitions defines transitions during a timeline for which a plurality of media content segments overlap in time and wherein the at least one pattern of transitions specifies a sequence of media content segments to be selected to represent the timeline.

12. The method according to claim 11, wherein the sequence of media content segments defines at least one transition time and specifies a new media content segment to which a transition is to be made from an old media content segment at the at least one transition time, based at least in part on similarity between the old media content segment and the new media content segment.

13. The method according to claim 8, wherein at least one of the media content segments is an audio only segment.

14. The method according to claim 8, wherein at least one of the media content segments includes audio and video.

15. A computer readable medium storing a program of instructions, execution of which by a processor configures an apparatus to at least:
determine similarity information relating to media content segments associated with different sources; and
determine at least one pattern of transitions between media content segments based at least in part on the similarity information.

16. The computer readable medium according to claim 15, wherein the sources are media capture devices distributed in a space, and wherein each media content segment comprises data captured by a device during a specified time period, and wherein similarity information is determined based at least in part on similarity between data captured by different devices during the same time period.

17. The computer readable medium according to claim 16, wherein similarity information is determined between pairs of media content segments, and wherein pairs are organized based on similarity between members of pairs as a function of time.

18. The computer readable medium according to claim 15, wherein the at least one pattern of transitions defines transitions during a timeline for which a plurality of media content segments overlap in time and wherein the at least one pattern of transitions specifies a sequence of media content segments to be selected to represent the timeline.

19. The computer readable medium according to claim 18, wherein the sequence of media content segments defines at least one transition time and specifies a new media content segment to which a transition is to be made from an old media content segment at the at least one transition time, based at least in part on similarity between the old media content segment and the new media content segment.

20. The computer readable medium according to claim 15, wherein at least one of the media content segments is an audio only segment.

21. The computer readable medium according to claim 15, wherein at least one of the media content segments includes audio and video.

22-28. (canceled)
